(19) United States
(12) Patent Application Publication
(10) Pub. No.: US 2002/0180667 A1
(43) Pub. Date: Dec. 5, 2002

(54) Method for operating plasma display panel

(76) Inventor: Bong Chool Kim, Gumi-shi (KR)

Correspondence Address: Merchant & Gould, PO Box 2903, Minneapolis, MN, 55402-0903, US

(21) Appl. No.: 10/148,725

(22) PCT Filed: Nov. 29, 2000
(86) PCT No.: PCT/KR00/01377

(30) Foreign Application Priority Data
Nov. 30, 1999 (KR) 1999/54061

(51) Int. Cl. G09G 3/28

(52) U.S. Cl. 345/60

(57) ABSTRACT

Each of sub-field of a plasma display panel have a total writing period for total erasing, an address period for erasing selectively, and a sustaining period for supplying a sustaining pulse. A writing pulse with adjusted voltage level and pulse width for total erasing is supplied only once during the total writing period. So, the contrast is improved.

### TECHNICAL FIELD

The present invention relates to a method for driving a plasma display panel, and in particular to a method for driving a plasma display panel which can improve a contrast, by improving a total erase pulse applied in a total write period according to a selective erase operation based on an address display period separation(ADS) method.

### BACKGROUND ART

According to a conventional ADS method for a plasma display panel, two step operations, that is a total erase operation and a polarity inversion are executed in a total write period. Here, pulses are applied once for executing each of the total erase operation and the polarity inversion, and the total write period undergoes twice application of pulses. Accordingly, this twice application of pulses in the total write period is due to reducing a back contrast of the plasma display panel.

In a selective erase operation as illustrated in FIG. 1, a write pulse Vw of a total erase pulse is applied to an X electrode in the total write period, and then a pulse Vy for polarity inversion is applied to an Y electrode. Then, a pulse Ve for selective erasing is applied to the Y electrode in an addressing period. Thereafter, a sustain pulse Vsus is applied to the X and Y electrodes in the sustain period at a predetermined frequency. Here, a voltage level of the total erase pulse Vw of the X electrode is over 350V, and thus is higher than a voltage level of the sustain pulse Vsus applied in the sustain period.

In the conventional method for driving the plasma display panel as shown in FIG. 1, the pulses are applied twice for the total erase operation and the polarity inversion, thereby increasing background luminance. As a result, the contrast is reduced. As depicted in FIG. 1, a relative optical value of the total write period is ‘3.5(2+1.5=3.5)’. That is, the background luminance of one frame is about 4 cd/m². Accordingly, when a peak luminance is 400 cd/m², a black level contrast is about 100:1.

As shown in FIG. 2 of depicting a write operation according to the conventional ADS method, the write pulse and the polarity inversion pulse are applied to the X and Y electrodes. Here, a relative optical value in the total write period is (2+1.5=3.5), which is identical to that in FIG. 1. An average luminance of the black level of each sub field is 0.5 cd/m². In the case that one frame has eight sub fields, the background luminance of one frame corresponds to 4 cd/m². Therefore, when the peak luminance is 400 cd/m², the black level contrast is about 100:1.

As depicted in FIG. 3, in an erase operation of the ADS method, the black level contrast is slightly improved. Nevertheless, the write pulse and the inversion pulse are applied to the X and Y electrodes in the total write period, and thus the relative optical value becomes ‘2.5(1.5+1=2.5)’. Accordingly, the background luminance of one frame is 2.88 cd/m². Thus, when the peak luminance is 400 cd/m², the black level contrast is about 140:1.

As described above, in the conventional method for driving the plasma display panel, the selective erase operation according to the ADS driving method increases a sustain discharge number by reducing an addressing time, thereby improving luminance. However, the total erase operation and the polarity inversion are repeatedly performed in the total write period, and thus the write operation is carried out twice in the total write period of one frame. As a result, the background luminance is increased, and thus the black level contrast is decreased.

### DISCLOSURE OF THE INVENTION

Therefore, an object of the present invention is to provide a method for driving a plasma display panel according to a selective erase operation based on an address display-period separation method, which can improve a black level contrast, by performing a write operation for total erasing in a total write period of each sub field by using one write pulse having an improved potential and pulse width.

In order to achieve the above-described object of the present invention, there is provided a method for driving a plasma display panel wherein each frame is divided a plurality of sub-fields, wherein each sub field consists of a total write period where a write operation is performed in a cell by a pulse applied from a scan electrode and a display electrode, an addressing period where a selective erase operation is performed by an erase pulse, and a sustain period where a sustain pulse is applied, and a write pulse having a potential difference below 300V, preferably below 280V and a pulse width over 20 μsec is applied once to perform one write operation in the total write period.

Here, the write pulse may be applied only to the scan electrode, or may be simultaneously applied to the scan and display electrodes.

In addition, a width of the write pulse may be extended in a specific potential in order to guarantee a settable minimum luminance.

### BRIEF DESCRIPTION OF THE DRAWINGS

FIG. 1 is a waveform diagram of driving pulses in a selective erase operation of a conventional method for driving a plasma display panel;

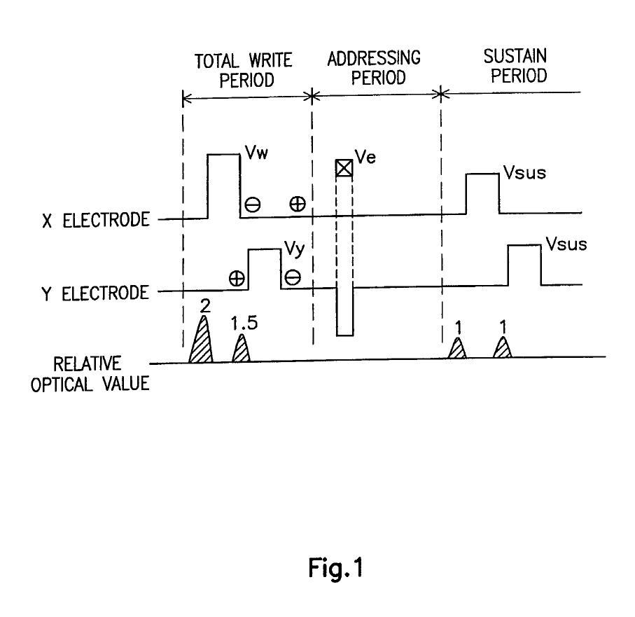

FIG. 2 is a waveform diagram of driving pulses in a write operation based on an ADS method of the conventional method for driving the plasma display panel;

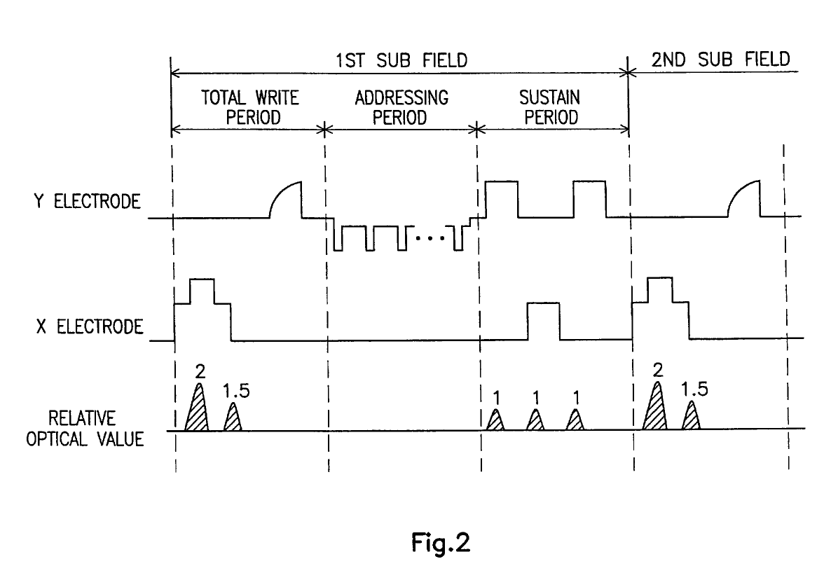

FIG. 3 is a waveform diagram of driving pulses in an erase operation based on the ADS method of the conventional method for driving the plasma display panel;

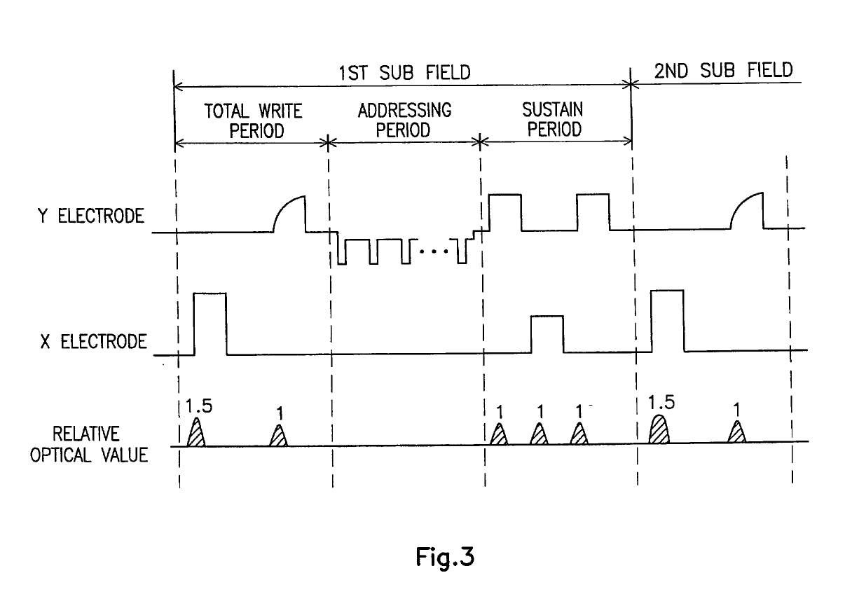

FIG. 4 is a circuit diagram illustrating a plasma display panel where the present invention is implemented;

FIG. 5 is a waveform diagram of driving pulses in accordance with a first embodiment of the present invention; and

FIG. 6 is a waveform diagram of driving pulses in accordance with a second embodiment of the present invention.

### MODES FOR CARRYING OUT THE PREFERRED EMBODIMENTS

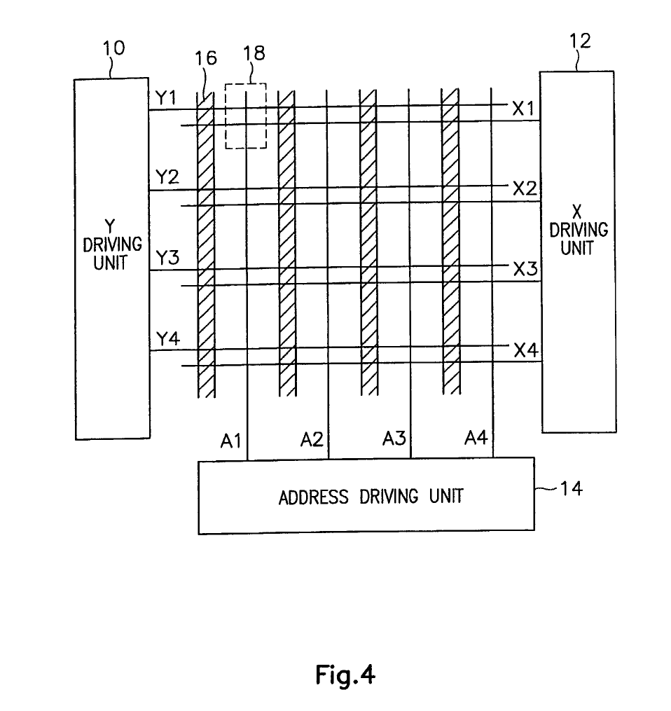

FIG. 4 is a circuit diagram illustrating a plasma display panel where the present invention is implemented.

The plasma display panel consists of an upper substrate and a lower substrate. Scan electrodes Y1˜Y4 and display electrodes X1˜X4 are formed on the upper substrate, and address electrodes A1˜A4 are formed on the lower substrate. In addition, cells 18 where a discharge operation is generated are formed in cross regions of the electrodes of the upper and lower substrates.

The respective frames composing a screen are divided into eight sub fields. The three-step process of a total write operation, an addressing operation and a sustain operation is performed in each sub field. The eight sub fields are combined in parallel to compose one screen. A user can recognize the screen by an afterimage effect.

Referring to FIG. 4, an Y driving unit 10 applies pulses to the scan electrodes Y1˜Y4 of the respective cells 18, and an X driving unit 12 applies pulses to the display electrodes X1˜X4 of the respective cells 18. An address driving unit 14 applies address pulses to the address electrodes A1˜A4 crossing the scan and display electrodes. In addition, cross walls 16 are formed to divide the cells.

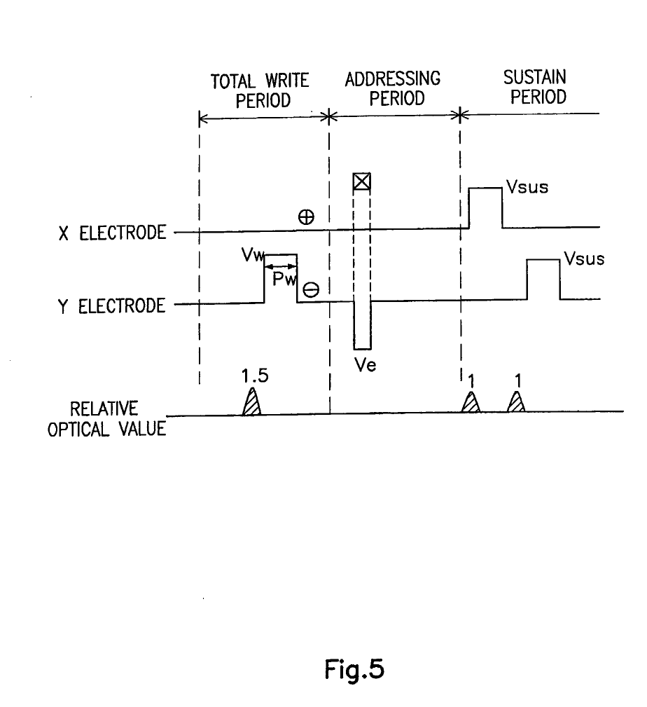

According to a first embodiment of the present invention, as shown in FIG. 5, each sub field is divided into a total write period, an addressing period and a sustain period. In the total write period, a write pulse Vw for total erasure has a positive potential and a pulse width of PW, and is applied to the Y electrode which is the scan electrode. The write pulse is not applied to the X electrode which is the display electrode. Accordingly, the write operation for total erasure is performed in the total write period. On the other hand, in the addressing period, an erase pulse Ve is applied to the Y electrode which is the scan electrode, thereby performing the selective erase operation. Thereafter, in the sustain period, a sustain pulse Vsus is applied to the Y electrode and the X electrode, thereby carrying out the sustain discharge operation.

Here, the write pulse applied to the Y electrode has a potential below 300V, preferably below 280V. In addition, the width of the write pulse is extended more than that of the conventional write pulse, and is preferably over 20 μsec. At this time, the pulse width can be adjusted to obtain a time for supplying a current for a desired black level luminance at a predetermined voltage level.

In accordance with the first embodiment of the present invention, when the write pulse as shown in FIG. 5 is applied in the total write period, a relative optical value reaches into 1.5. It implies that an average luminance of the black level in each sub field corresponds to 0.2 cd/m². As a result, a background luminance of one frame consisting of the eight sub fields is 1.6 cd/m². Accordingly, when a peak luminance is 400 cd/m², a black level contrast is about 250:1.

Consequently, the black level contrast is improved to about 250:1.

As described above, the write pulse Vw has a voltage level below 300V. Such voltage may be provided by programming variations of the Y driving unit 10 in FIG. 4. In addition, a scan drive integrated circuit(not shown) in the Y driving unit 10 may provide a voltage of 200V, and then the residual voltage may be compensated by using an additional switching unit and a ground.

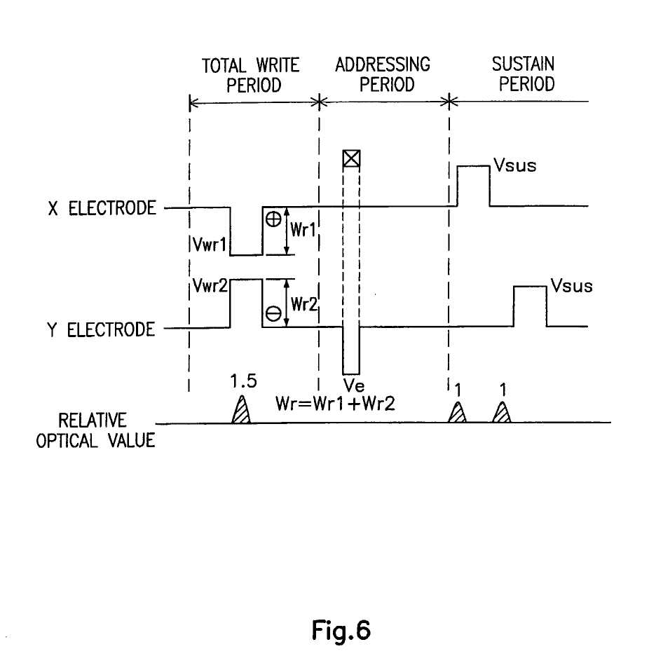

A method for driving a plasma display panel in accordance with a second embodiment of the present invention will now be described with reference to FIG. 6.

Identically to the first embodiment, the total write, addressing and sustain operations are performed in each sub field. However, in the total write period, a pulse Vwr1 having a negative level of Wr1 is applied to the X electrode which is the display electrode, and a pulse Vwr2 having a positive level of Wr2 is applied to the Y electrode which is the scan electrode. Here, the pulses are applied to the X and Y electrodes at the same time, and a width of the pulses are identical.

That is, in accordance with the second embodiment of the present invention, one pulse is applied to the X and Y electrodes as the write pulse at the same time. Here, a potential difference between the pulse of the X electrode and the pulse of the Y electrode is Wr. Identically to the first embodiment, the potential difference is below 300V, preferably below 280V. In addition, the width of the pulse is extended more than that of the conventional pulse. Preferably, the pulse width is over 20 μsec to obtain a desired black level luminance by using a pulse below 300V.

In accordance with the second embodiment of the present invention, when the write pulse as shown in FIG. 6 is applied in the total write period, the write pulse has the potential difference to the first embodiment, and thus the relative optical value reaches into 1.5. Accordingly, when the peak luminance is 400 cd/m², the black level contrast is about 250:1.

As discussed earlier, the write operation is performed by one pulse in the total write period in the respective sub frames. The pulse has a relatively low potential and a wide pulse width to supply sufficient current. Therefore, the background luminance is decreased, and the black level contrast is improved.

When the present invention is employed to drive the plasma display panel, the contrast improvement is achieved. As a result, the sufficient contrast for a high quality screen is provided to the plasma display panel, thereby improving reliability of the plasma display panel.

What is claimed:

1. A method for driving a plasma display panel wherein each frame is divided a plurality of sub-fields, wherein each sub field consists of a total write period where a write operation is performed in a cell by a pulse applied from a scan electrode and a display electrode, an addressing period where a selective erase operation is performed by an erase pulse, and a sustain period where a sustain pulse is applied, and a write pulse having a potential difference below 300V and a pulse width over 20 μsec is applied to the scan electrode to perform one write operation in the total write period.

2. The method according to claim 1, wherein the write pulse is below 280V.

3. The method according to claim 1, wherein a width of the write pulse is extended in a specific potential to guarantee a settable minimum luminance.

4. A method for driving a plasma display panel wherein each frame is divided a plurality of sub fields, wherein each sub field consists of a total write period where a write operation is performed in a cell by a pulse applied from a scan electrode and a display electrode, an addressing period where a selective erase operation is performed by an erase pulse, and a sustain period where a sustain pulse is applied, and a positive pulse is applied to the scan electrode and a negative pulse is applied to the display electrode at the same time to perform one write operation in the total write period, the pulses having a potential difference below 300V and a pulse width over 20 μsec.

5. The method according to claim 4, wherein the write pulse is below 280V.

6. The method according to claim 4, wherein a width of the write pulse is extended in a specific potential to guarantee a settable minimum luminance.
